(19) United States
(12) Patent Application Publication
(10) Pub. No.: US 2021/0119937 A1
(43) Pub. Date: Apr. 22, 2021

(54) SYSTEM FOR CONSOLIDATING AND PROCESSING MULTIPLE RESOURCE REQUESTS

(71) Applicant: BANK OF AMERICA CORPORATION, CHARLOTTE, NC (US)

(72) Inventors: Christina Ann Lillie, Ann Arbor, MI (US); Heather Roseann Dolan, Sarasota, FL (US); Justin Riley duPont, Charlotte, NC (US); Malathi Jivan, San Jose, CA (US)

(73) Assignee: BANK OF AMERICA CORPORATION, CHARLOTTE, NC (US)

(21) Appl. No.: 16/656,013

(22) Filed: Oct. 17, 2019

(51) Int. Cl. H04L 12/911; H04L 12/927; H04L 12/917

(52) U.S. Cl. CPC H04L 47/827; H04L 47/828; H04L 47/72; H04L 47/76; H04L 47/808

(57) ABSTRACT

Embodiments of the present invention provide a system for consolidating and processing multiple resource requests. The system is configured for receiving at least two resource requests from a first user, identifying that the at least two resource requests are associated with a second user, consolidating the at least two resource requests, and processing the consolidated at least two resource requests.

### BACKGROUND

Conventional systems do not have the capability to consolidate and process multiple resource requests. As such, there exists a need for a system to effectively consolidate and process multiple resource requests.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for consolidating and processing multiple resource requests. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention receives at least two resource requests from a first user, identifies that the at least two resource requests are associated with a second user, consolidates the at least two resource requests, and processes the consolidated at least two resource requests.

In some embodiments, each of the at least two resource requests comprise user information associated with the second user.

In some embodiments, the present invention generates a parent identification number and assigns the parent identification number to the consolidated at least two resource requests.

In some embodiments, the present invention displays the parent identification number associated with the consolidated at least two resource requests to the first user on a user device, displays consolidated resources associated with the consolidated at least two resource requests to the first user on the user device, and prompts the first user to approve the consolidated at least two resource requests.

In some embodiments, the present invention processes the consolidated at least two resource requests after receiving an approval from the first user in response to prompting the first user to approve the consolidated at least two resource requests.

In some embodiments, the present invention generates and assigns a unique ID to each of the at least two resource requests.

In some embodiments, the present invention links the unique ID associated with each of the at least two resource requests with the parent identification number.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for consolidating and processing multiple resource requests, in accordance with an embodiment of the invention;

FIG. 2 provides a block diagram illustrating the entity system 200 of FIG. 1, in accordance with an embodiment of the invention;

FIG. 3 provides a block diagram illustrating a consolidating system 300 of FIG. 1, in accordance with an embodiment of the invention;

FIG. 4 provides a block diagram illustrating the computing device system 400 of FIG. 1, in accordance with an embodiment of the invention; and

FIG. 5 provides a flowchart illustrating a process flow for consolidating and processing multiple resource requests, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “entity” may include any organization that processes financial transactions including, but not limited to, banks, credit unions, savings and loan associations, investment companies, stock brokerages, asset management firms, insurance companies and the like. In accordance with embodiments of the invention, the terms “third party system” and “other third party systems” may include any organization that processes financial transactions including, but not limited to, banks, credit unions, savings and loan associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution or a potential customer of the financial institution or an employee of the financial institution.

In accordance with embodiments of the invention, a “resource pool” or an “account” is the relationship that a customer has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, a non-monetary user profile that includes information associated with the user, or the like. The account is associated with and/or maintained by the entity.

In accordance with embodiments of the invention, a “resource interaction,” “resource request,” “resource interaction request” may be a transaction, transfer of funds, transfer of resources between two users, a user and an entity, a user and a third party entity, and/or entity and a third party system. Transfer of resources may refer to a payment, processing of funds, international transfer of funds, purchase of goods or services, a return of goods or services, a payment transaction, a credit transaction, or other interactions involving user's resource or account.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

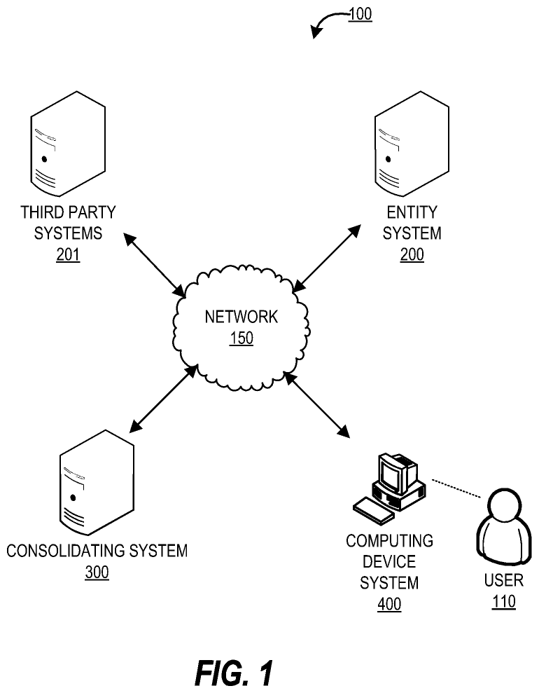

FIG. 1 provides a block diagram illustrating a system environment 100 for consolidating and processing multiple resource requests, in accordance with an embodiment of the invention. As illustrated in FIG. 1, the environment 100 includes a consolidating system 300, entity system 200, a computing device system 400, and one or more third party systems 201. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200.

The entity system(s) 200 may be any system owned or otherwise controlled by an entity to support or perform one or more process steps described herein. The entity may be any organization which develops or manages applications. In some embodiments, the managing entity is a financial institution. In some embodiments, the managing entity is a non-financial institution.

The consolidating system 300 is a system of the present invention for performing one or more process steps described herein. In some embodiments, the consolidating system 300 may be an independent system. In some embodiments, the consolidating system 300 may be a part of the entity system 200.

The consolidating system 300, the entity system 200, the computing device system 400, and/or the third party systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the consolidating system 300 is configured to communicate information or instructions with the entity system 200, the computing device system 400, and/or the third party systems 201 across the network 150.

The computing device system 400 may be a system owned or controlled by the entity of the entity system 200, the user 110, and/or a third party that specializes in processing of the resource distribution applications in the system environment 100. As such, the computing device system 400 may be a computing device of the user 110. In general, the computing device system 400 communicates with the user 110 via a user interface of the computing device system 400, and in turn is configured to communicate information or instructions with the consolidating system 300, entity system 200, and/or the third party systems 201 across the network 150.

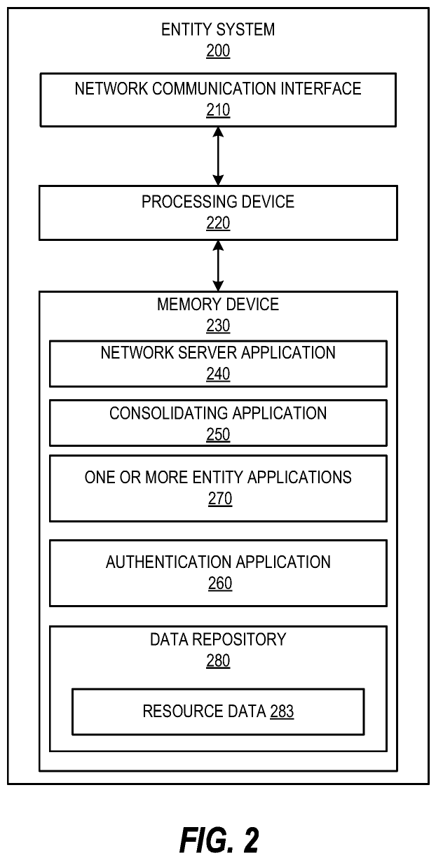

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a consolidating application 250, one or more entity applications 270, an authentication application 260, and a data repository 280 comprising resource data 283 and user data (not shown). The computer-executable program code of the network server application 240, the consolidating application 250, the one or more entity applications 270, and the authentication application 260 to perform certain logic, data-extraction, and data-storing functions of the entity system 200 described herein, as well as communication functions of the entity system 200.

The network server application 240, the consolidating application 250, the one or more entity applications 270, and the authentication application 260 are configured to store data in the data repository 280 or to use the data stored in the data repository 280 when communicating through the network communication interface 210 with the consolidating system 300, the computing device system 400, and/or the third party systems 201 to perform one or more process steps described herein. In some embodiments, the entity system 200 may receive instructions from the consolidating system 300 via the consolidating application 250 to perform certain operations. The consolidating application 250 may be provided by the consolidating system 300. The one or more entity applications 270 may be any of the applications used, created, modified, and/or managed by the entity system 200. The authentication application 260 may be used to authenticate one or more users 110 to access the one or more entity applications 270 and the data repository 280.

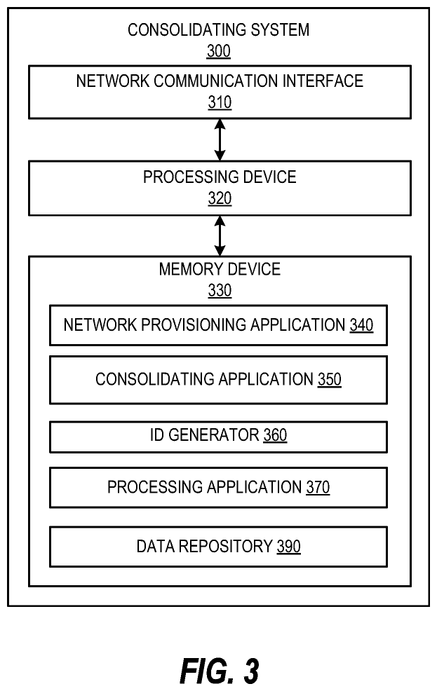

FIG. 3 provides a block diagram illustrating the consolidating system 300 in greater detail, in accordance with embodiments of the invention. As illustrated in FIG. 3, in one embodiment of the invention, the consolidating system 300 includes one or more processing devices 320 operatively coupled to a network communication interface 310 and a memory device 330. In certain embodiments, the consolidating system 300 is operated by a first entity, such as a financial institution, while in other embodiments, the consolidating system 300 is operated by an entity other than a financial institution. In some embodiments, the consolidating system 300 is owned or operated by the entity of the entity system 200. In some embodiments, the consolidating system 300 may be an independent system. In alternate embodiments, the consolidating system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the consolidating system 300 described herein. For example, in one embodiment of the consolidating system 300, the memory device 330 includes, but is not limited to, a network provisioning application 340, a consolidating application 350, an ID generator 360, a processing application 370, and a data repository 390 comprising data processed or accessed by one or more applications in the memory device 330. The computer-executable program code of the network provisioning application 340, the consolidating application 350, the ID generator 360, and the processing application 370, may instruct the processing device 320 to perform certain logic, data-processing, and data-storing functions of the consolidating system 300 described herein, as well as communication functions of the consolidating system 300.

The network provisioning application 340, the consolidating application 350, the ID generator 360, and the processing application 370 are configured to invoke or use the data in the data repository 390 when communicating through the network communication interface 310 with the entity system 200, the computing device system 400, and/or the third party systems 201. In some embodiments, the network provisioning application 340, the consolidating application 350, the ID generator 360, and the processing application 370 may store the data extracted or received from the entity system 200, the third party system 201, and the computing device system 400 in the data repository 390. In some embodiments, the network provisioning application 340, the consolidating application 350, the ID generator 360, and the processing application 370 may be a part of a single application.

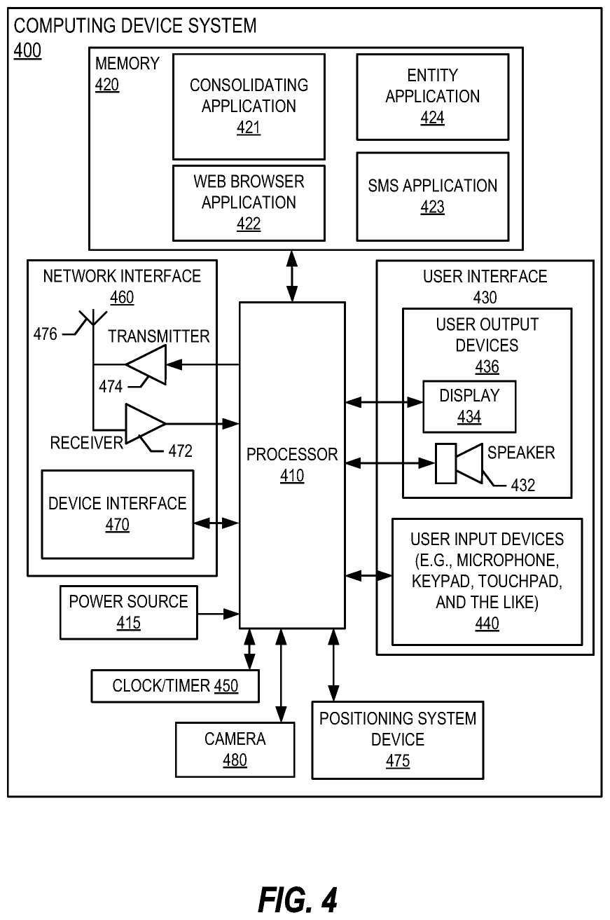

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a consolidating application 421, entity application 424. These applications also typically instructions to a graphical user interface (GUI) on the display 430 that allows the user 110 to interact with the entity system 200, the consolidating system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the consolidating application 421 provided by the consolidating system 300 allows the user 110 to access the one or more electronic resources stored in the entity system and/or the consolidating system 300. In some embodiments, the entity application 424 provided by the entity system 200 and the consolidating application 421 allow the user 110 to access one or more electronic resources and one or more entity applications 270.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

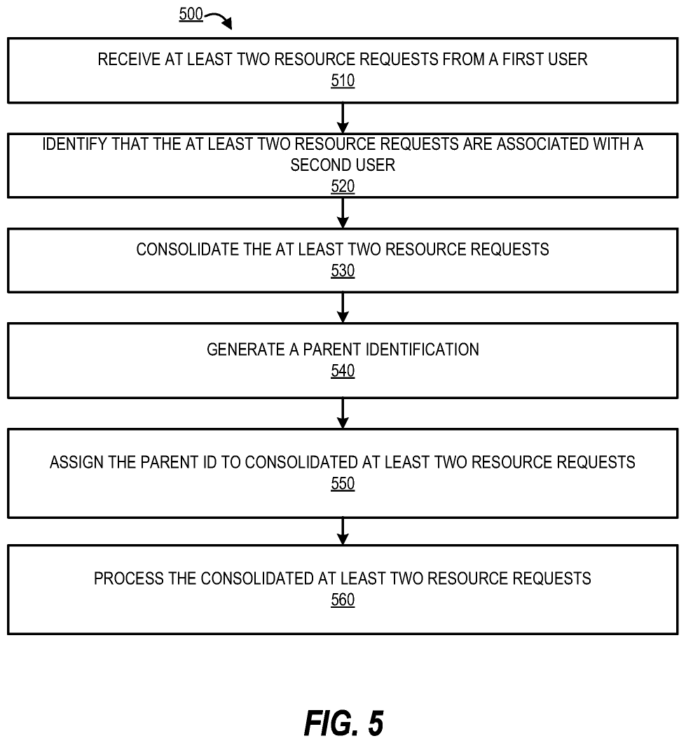

FIG. 5 provides a flowchart illustrating a process flow 500 for consolidating and processing multiple resource requests, in accordance with an embodiment of the invention. As shown in block 510, the system receives at least two resource requests from a first user. The at least two resource requests may be transfer of resources from a resource pool of the first user to another resource pool of a second user, an entity, or a third party entity. The system may automatically generate and assign a unique transaction ID to each of the at least two resource requests in response to receiving the at least two resource requests from the first user. The first user is a sender of the at least two requests. The at least two resource requests comprise recipient information, resource amount, transaction date, transaction time, and the like. In some embodiments, the system receives the at least two resource requests on two separate days. In some embodiments, the system receives the at least two resource requests on a same day at different times.

As shown in block 520, the system identifies that the at least two resource requests are associated with a second user, where the second user is the recipient of the at least two resource requests. The system identifies that the at least two resource requests are associated with the second user based on the recipient information. In some embodiments, the second user may initiate a request for payment. In such an embodiment, in response to receiving the request for payment, the first user initiates the each of the at least two resource requests. For example, a child care taker (e.g., nanny) may initiate a request for payment from a parent every day for the services provided. In response to receiving the requests, the parent may initiate the transactions. Typically, in conventional systems the first user has to approve every resource request and each resource request is processed individually. This process of processing every resource request is not efficient, consumes more memory and processing capability of the processing systems, and is not cost effective. In order to make the process more efficient, the system, as shown in block 530, consolidates the at least two resource requests. In response to identifying that the at least two requests are associated with the second user, the system consolidates the at least two requests.

As shown in block 540, the system generates a parent identification. The system generates a unique parent ID. In some embodiments, the unique parent ID may be based on each of the unique ID's of each of the resource requests. In some embodiments, the system links the unique ID's of each of the resource requests with the unique parent ID. As shown in block 550, the system assigns the parent ID to consolidated at least two resource requests.

As shown in block 560, the system processes the consolidated at least two resource requests. The system processes the at least two resource requests associated with the parent ID together. Processing the resource request may include settling the resource requests using any of the payment rails. The payment rails may include, but are not limited to, ACH, real-time processing, wire transfer, P2P transfer, or the like. Settling the resource request may comprise transferring resources from a resource pool of the first user to a second resource pool of the second user. In some embodiments, the system processes the at least two resource requests after receiving an approval from the user.

In some embodiments, the system consolidates the at least two resource requests and displays the consolidated at least two resource requests to the first user for approval via a graphical user interface of the user computing user device of the first user. The system may then prompt the first user for approval. The system allows the user to approve the consolidated at least two resource requests via single click. For example, the system may display the total amount for all the consolidated at least two resource requests and the parent ID associated with the consolidated at least two resource requests and allows the user to approve via single click. In some embodiments, the system may also display each of the at least two resource requests upon request. For example, the system may allow the first user to click on the parent ID to view each of the at least two resource requests that are embedded in a collapsed format under the parent ID. In some embodiments, the system may display the consolidated at least two resource requests at the end of a week or end of a month. In some embodiments, the system consolidates resource requests that are associated with different recipients.

In some embodiments, the system consolidates the resource requests based on user input. For example, the first user may choose to consolidate four resource requests out of five resource requests. In some embodiments, the system may consolidate multiple resource requests based on historical data associated with consolidation of resource requests. In some embodiments, the system may automatically consolidate multiple resource requests based on user preferences.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for consolidating and processing multiple resource requests, the system comprising:
at least one non-transitory storage device; and
at least one processing device coupled to the at least one non-transitory storage device, wherein the at least one processing device is configured to:
receive at least two resource requests from a first user;
identify that the at least two resource requests are associated with a second user;
consolidate the at least two resource requests;
generate a parent identification number;
assign the parent identification number to the consolidated at least two resource requests initiated by the first user; and
process the consolidated at least two resource requests.

2. The system of claim 1, wherein each of the at least two resource requests comprise user information associated with the second user.

3. (canceled)

4. The system of claim 1, wherein the at least one processing device is configured to process the consolidated at least two resource requests based on:
displaying the parent identification number associated with the consolidated at least two resource requests to the first user on a user device;
displaying consolidated resources associated with the consolidated at least two resource requests to the first user on the user device; and
prompting the first user to approve the consolidated at least two resource requests.

5. The system of claim 4, wherein the at least one processing device is further configured to process the consolidated at least two resource requests after receiving an approval from the first user in response to prompting the first user to approve the consolidated at least two resource requests.

6. The system of claim 1, wherein the at least one processing device is configured to generate and assign a unique ID to each of the at least two resource requests.

7. The system of claim 6, wherein the at least one processing device is configured to link the unique ID associated with each of the at least two resource requests with the parent identification number.

8. A computer program product for consolidating and processing multiple resource requests, the computer program product comprising a non-transitory computer-readable storage medium having computer executable instructions for causing a computer processor to perform the steps of:
receiving at least two resource requests from a first user;
identifying that the at least two resource requests are associated with a second user;
consolidating the at least two resource requests;
generating a parent identification number;
assigning the parent identification number to the consolidated at least two resource requests initiated by the first user; and
processing the consolidated at least two resource requests.

9. The computer program product of claim 8, wherein each of the at least two resource requests comprise user information associated with the second user.

10. (canceled)

11. The computer program product of claim 8, wherein the computer executable instructions cause the computer processor to process the consolidated at least two resource requests based on:
displaying the parent identification number associated with the consolidated at least two resource requests to the first user on a user device;
displaying consolidated resources associated with the consolidated at least two resource requests to the first user on the user device; and
prompting the first user to approve the consolidated at least two resource requests.

12. The computer program product of claim 11, wherein the computer executable instructions cause the computer processor to process the consolidated at least two resource requests after receiving an approval from the first user in response to prompting the first user to approve the consolidated at least two resource requests.

13. The computer program product of claim 8, wherein the computer executable instructions cause the computer processor to generate and assign a unique ID to each of the at least two resource requests.

14. The computer program product of claim 13, the computer executable instructions cause the computer processor to link the unique ID associated with each of the at least two resource requests with the parent identification number.

15. A computerized method consolidating and processing multiple resource requests, the method comprising:
receiving at least two resource requests from a first user;
identifying that the at least two resource requests are associated with a second user;
consolidating the at least two resource requests;
generating a parent identification number;
assigning the parent identification number to the consolidated at least two resource requests initiated by the first user; and
processing the consolidated at least two resource requests.

16. The computerized method of claim 15, wherein each of the at least two resource requests comprise user information associated with the second user.

17. (canceled)

18. The computerized method of claim 15, wherein processing the consolidated at least two resource requests is based on:
displaying the parent identification number associated with the consolidated at least two resource requests to the first user on a user device;
displaying consolidated resources associated with the consolidated at least two resource requests to the first user on the user device; and
prompting the first user to approve the consolidated at least two resource requests.

19. The computerized method of claim 18, wherein processing the consolidated at least two resource requests is based on receiving an approval from the first user in response to prompting the first user to approve the consolidated at least two resource requests.

20. The computerized method of claim 15, wherein the method further comprises:
generate and assign a unique ID to each of the at least two resource requests; and
link the unique ID associated with each of the at least two resource requests with the parent identification number.
